(19) United States
(12) Patent Application Publication
(10) Pub. No.: US 2013/0109262 A1
(43) Pub. Date: May 2, 2013

(54) COATED POROUS MATERIALS

(71) Applicant: Jinsheng Zhou, Woodbury, MN (US)

(72) Inventor: Jinsheng Zhou, Woodbury, MN (US)

(73) Assignee: 3M INNOVATIVE PROPERTIES COMPANY, ST. PAUL, MN (US)

(21) Appl. No.: 13/699,405

(22) PCT Filed: May 11, 2011
(86) PCT No.: PCT/US2011/036046

§ 371 Date: Jan. 9, 2013

Related U.S. Application Data
(60) Provisional application No. 61/350,147, filed on Jun. 1, 2010.
(60) Provisional application No. 61/351,441, filed on Jun. 4, 2010.

(51) Int. Cl. C09D 5/00

(52) U.S. Cl. CPC C09D 5/00
USPC 442/118; 428/131; 427/230; 427/517

(57) ABSTRACT

A coated porous material and a method for making the same. The coated porous material includes a porous substrate having a plurality of pores. A hydrophilic coating including, in a single layer, ethylene vinyl alcohol copolymer and at least one crosslinked polymer, is present on a plurality of inner pore walls. The method includes: (a) providing a porous substrate; (b) applying a coatable composition to at least a portion of the inner pore walls of the porous substrate, the coatable composition made of ethylene vinyl alcohol copolymer, at least one polymerizable compound and solvent; (c) removing at least a portion of the solvent from the coatable composition to dry the coatable composition; (d) saturating the porous substrate and the coatable composition with a rewetting solution; and (e) polymerizing the polymerizable compound to form the hydrophilic coating on the pore walls and to provide the coated porous material.

### CROSS REFERENCE TO RELATED APPLICATION

This application claims the benefit of U.S. Provisional Patent Application Nos. 61/350,147, filed Jun. 1, 2010; and 61/351,441, filed Jun. 4, 2010, the disclosures of which are incorporated by reference herein in their entireties.

### TECHNICAL

This invention relates to coated porous materials that include hydrophilic coatings, to a process for the preparation of the coated porous materials and to the use of the coated porous materials as a separation medium.

### BACKGROUND

Reducing the hydrophobicity (or increasing the hydrophilicity) of a filtration substrate (e.g., a membrane) is desired in order to reduce fouling during use. While many of the least expensive and most stable substrate-forming materials are hydrophobic polymers, the art has developed methods for modifying the polymer surface of a substrate to render it hydrophilic and thus more readily wettable with water. To decrease the hydrophobicity inherent to many polymeric materials, the art has known to either chemically modify the surface and pore-walls of a substrate or, alternatively, to coat the walls of the pores in the substrate with a hydrophilic layer, the layer usually being polymeric in nature. The hydrophilic layer improves the affinity of the substrate material towards water, increasing its wettability and, in some cases, making the substrate completely wettable by water.

Early efforts in the art to adhere the hydrophilic layer to a substrate included activating the walls of the pores in the substrate (e.g., with a plasma treatment) such that a hydrophilic coating could be chemically attached to the pore walls. The attachment of grafted coatings can also be made by depositing a mixture of monomers within the pores of the substrate and inducing a polymerization reaction in a manner that promotes grafting of the thus formed hydrophilic polymer to the walls of the substrate. However, in the absence of substantial crosslinking, a grafted layer can become hydrated and expand to the point of essentially filling and blocking the pores of the substrate.

Although the art of hydrophilic filtration media has seen some advances, more improvements are desired.

### SUMMARY

The present invention provides hydrophilic filtration media that include a porous substrate rendered hydrophilic by the application of a coatable composition which, upon further treatment, provides a hydrophilic coating on the pore walls of the substrate. The resulting filtration media demonstrates a low level of swelling when wet and possesses a surface that is rich in polar functional groups. The filtration media experiences minimal pore-plugging in use and typically demonstrates a high surface energy. Moreover, the filtration media is readily made using an efficient process.

In an embodiment, the invention provides a coated porous material comprising:
a) a porous substrate comprising a plurality of pores extending through the substrate from a first major surface to a second major surface, each pore comprising an inner pore wall defining the internal dimension of the pore; and
b) a hydrophilic coating on a plurality of the pore walls, the hydrophilic coating comprising ethylene vinyl alcohol copolymer and at least one crosslinked polymer in a single layer.

In another embodiment, the invention provides a process for the preparation of the coated porous material, the process comprising:
a) providing a porous substrate comprising a plurality of pores extending through the substrate from a first major surface to a second major surface, each pore comprising an inner pore wall defining the internal dimension of the pore;
b) applying a coatable composition to at least a portion of the inner pore walls of the porous substrate, the coatable composition comprising ethylene vinyl alcohol copolymer, at least one polymerizable compound and solvent;
c) removing at least a portion of the solvent from the coatable composition to dry the coatable composition;
d) saturating the porous substrate and the coatable composition with a rewetting solution; and
e) polymerizing the polymerizable compound to form a hydrophilic coating on the pore walls and to provide the coated porous material, the hydrophilic coating comprising both the ethylene vinyl alcohol copolymer and a crosslinked polymer in a single layer.

Various terms used herein to describe aspects of the various embodiments of the invention will be understood to have the meaning known to persons of ordinary skill in the art. For clarity, certain terms will be understood to have the meaning set forth herein.

As used herein, “hydrophilic” is used as being indicative of a property in which a molecule, substance or article demonstrates an affinity for water by, for example, hydrogen bonding with water.

As used herein, “interpenetrating polymer network” refers to two or more polymer networks which are at least partially interlaced on a molecular scale but not covalently bonded to each other. Such a network cannot be separated unless chemical bonds are broken.

As used herein, “a,” “an,” “the,” “at least one,” and “one or more” are used interchangeably. Thus, for example, an article that comprises “a” membrane can be interpreted to mean that the article includes “one or more” membranes.

Also herein, any recitation of a numerical range by endpoints includes all numbers subsumed within that range (e.g., 1 to 5 includes 1, 1.5, 2, 2.75, 3, 3.80, 4, 5, etc.).

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The above summary is not intended to describe all possible embodiments or every implementation of the present invention. Those of ordinary skill in the art will more fully understand the scope of the invention upon consideration of description that follows.

### DETAILED DESCRIPTION

Composite materials and, more particularly, coated porous materials are provided having a porous substrate and a hydrophilic coating on the walls of at least some of the pores within the substrate. The hydrophilic coating is a single layer of materials that includes ethylene vinyl alcohol (“EVAL”) copolymer and at least one crosslinked polymer. The presence of the hydrophilic coating within the pores of the substrate alters the surface properties of the substrate. The coated porous material is made according to a process wherein a coatable composition is deposited within the pores of a porous substrate, the coatable composition comprising EVAL copolymer and polymerizable compound such as one or more polymerizable monomer(s) and/or prepolymer(s) or oligomer(s). The polymerizable compound is reacted (e.g., polymerized) to create the hydrophilic coating.

### Porous Substrate

A porous substrate serves as a base material in the construction of filtration articles according to the various embodiments of the invention. Suitable porous substrates for use in the embodiments of the invention include any of a variety of materials having sufficient porosity for use in filtration applications. Typically, the substrate includes a first major surface and a second major surface with a plurality of pores extending through the substrate from the first major surface to the second major surface. The pores are dimensioned to permit the passage of a liquid or gas feed through the substrate while trapping particulates or other matter contained within the feed.

Suitable porous substrates include, but are not limited to, microporous membranes, nonwoven webs, and porous fibers. The porous base substrate may be formed from any material. In some embodiments, the substrate comprises one or more polymeric material(s) which can include, but are not limited to, polyolefins, poly(isoprenes), poly(butadienes), fluorinated polymers, chlorinated polymers, polyesters, polyamides, polyimides, polyethers, poly(ether sulfones), poly(sulfones), polyphenylene oxides, poly(vinyl acetate), copolymers of vinyl acetate, poly(phosphazenes), poly(vinyl esters), poly(vinyl ethers), poly(vinyl alcohols), and poly(carbonates). Suitable polyolefins include, but are not limited to, poly(ethylene), poly(propylene), poly(1-butene), copolymers of ethylene and propylene, alpha olefin copolymers (such as copolymers of 1-butene, 1-hexene, 1-octene, and 1-decene), poly(ethylene-co-1-butene) and poly(ethylene-co-1-butene-co-1-hexene). Suitable fluorinated polymers include, but are not limited to, poly(vinyl fluoride), poly(vinylidene fluoride), copolymers of vinylidene fluoride (such as poly(vinylidene fluoride-co-hexafluoropropylene), and copolymers of chlorotrifluoroethylene (such as poly(ethylene-co-chlorotrifluoroethylene). Suitable polyamides include, but are not limited to, poly(imino(1-oxohexamethylene)), poly(iminoadipoyliminohexamethylene), poly(iminoadipoyliminodecamethylene), and polycaprolactam. Suitable polyimides include, but are not limited to, poly(pyromellitimide). Suitable poly(ether sulfones) include, but are not limited to, poly(diphenylether sulfone) and poly(diphenylsulfone-co-diphenylene oxide sulfone). Suitable copolymers of vinyl acetate include, but are not limited to, poly(ethylene-co-vinyl acetate) and such copolymers in which at least some of the acetate groups have been hydrolyzed to afford various poly(vinyl alcohols).

In one exemplary embodiment, the porous substrate is a microporous substrate having an average pore size less than about 1.0 microns. Suitable microporous substrates include, but are not limited to, microporous membranes, and microporous fibers. A microporous substrate comprising one or more of the above-mentioned polymeric materials may be hydrophobic. In some embodiments, the microporous substrate comprises a hydrophobic microporous membrane made by a process comprising thermally-induced phase separation (TIPS) membrane. Suitable TIPS membranes and methods of making the same include those disclosed in U.S. Pat. Nos. 4,539,256, 4,726,989, 4,867,881, 5,120,594 and 5,260,360. One exemplary TIPS membrane suitable for use in embodiments of the present invention is a membrane comprising poly(vinylidene fluoride) (i.e., PVDF). Another exemplary TIPS membrane suitable for use in other embodiments of the invention is a TIPS membrane comprising polyolefin such as polypropylene. Still another exemplary TIPS membrane comprises ethylene-chlorotrifluoroethylene (ECTFE) copolymer such as are described in PCT International Pub. No. WO 2010/071764. Another suitable PVDF membrane is one prepared using a solvent induced phase separation process (SIPS) such as those commercially available from Millipore Corporation.

Many porous materials can be used as the substrate. In specific embodiments, the polymer is a polyolefin made by thermally induced phase separation (TIPS), or by non-solvent induced phase separation. Specific examples of commercially available polyolefin support materials include SUPOR® polyethersulfone membranes manufactured by Pall Corporation, Cole-Parmer® Teflon® membranes, Cole-Parmer® nylon membranes, cellulose ester membranes manufactured by Gelman Sciences, and Whatman® filter and papers. Non-polymeric support members, such as ceramic-based supports, can also be used.

In some embodiments, porous substrates comprise fibrous materials. Examples of fibrous porous substrate include nonwoven webs, woven materials, melt blown materials, and the like. In some embodiments, fibrous polyolefins are used such as non-woven fibrous polyesters or nonwoven fibrous polypropylenes, including those commercially available, for example, from Hollingsworth and Vose Company. Suitable melt blown or woven materials can comprise, for example, polyolefins, polyesters, polyamides or cellulosic materials.

Suitable porous substrates can be of various shapes and sizes, such as, for example, flat sheets, hollow fibers, and tubular membranes. In some embodiments, the support member is in the form of a flat sheet that has a thickness of from about 10 to about 1000 microns, in other embodiments from about 10 to about 500 microns, and in still other embodiments from about 10 to about 300 microns.

### Components of a Coatable Composition

Coated porous materials of the invention include a hydrophilic coating on the surfaces of a porous substrate. The hydrophilic coating is a single layer of EVAL copolymer and a crosslinked polymer, and the hydrophilic coating is formed from a coatable composition formulated to include EVAL copolymer and polymerizable compound in a suitable solvent. In general, EVAL copolymer is thought to facilitate the uniform deposition of polymerizable compound on the surfaces of the porous substrate.

In embodiments of the invention, the polymerizable compound is hydrophilic while being polymerizable in situ (e.g., after being deposited within the pores of the substrate). Suitable polymerizable compounds include monomers, prepolymers and/or oligomers having a (a) free-radically polymerizable group that is a first ethylenically unsaturated group and (b) an additional functional group that is a second ethylenically unsaturated group. Suitable monomers having two ethylenically unsaturated groups include, but are not limited to, polyalkylene glycol di(meth)acrylates. As used herein, the term polyalkylene glycol di(meth)acrylate is used interchangeably with the term polyalkylene oxide di(meth)acrylate. The term “(meth)acryl” as in (meth)acrylate is used to encompass both acryl groups as in acrylates and methacryl groups as in methacrylates.

In one exemplary embodiment, the crosslinked polymer results from the reaction of polyethylene glycol di(meth)acrylate monomer and crosslinking agent upon exposure to ultraviolet (“UV”) radiation. The polymerization of such monomer converts an otherwise hydrophobic porous substrate into a hydrophilic coated porous material with the hydrophilicity being attributable to the presence of polyalkylene oxide groups. In one desired embodiment, the polyethylene glycol diacrylate monomer is a polyethylene glycol di(meth)acrylate monomer (e.g., polyethylene glycol dimethacrylate having an average molecular weight of about 400 g/mole) alone or in combination with other monomers. The resulting hydrophilic coating can have a number of desired properties such as instant wettability.

In certain embodiments, a suitable monomer will be of a certain minimum molecular weight or larger so as to provide a highly crosslinked polymer in the resulting hydrophilic coating. Exemplary polyalkylene glycol di(meth)acrylates include polyethylene glycol di(meth)acrylate monomers and polypropylene glycol di(meth)acrylates monomers. Suitable polyethylene glycol diacrylate monomer include those having an average molecular weight of about 300 g/mole or greater, 400 g/mole or greater or 600 g/mole or greater. A suitable polyethylene glycol diacrylate monomer having a molecular weight of about 508 g/mole is commercially available, for example, under the trade designation “SR344;” a polyethylene glycol dimethacrylate monomer having an average molecular weight of about 598 g/mole is commercially available under the trade designation “SR603;” and a polyethylene glycol dimethacrylate monomer having a molecular weight of about 742 g/mole is commercially available under the trade designation “SR610,” methoxy polyethylene glycol acrylate having a molecular weight of 693 is commercially available under the designation “CD552” all of which are available from Sartomer Co., Inc., Exton, Pa. Polyethylene glycol diacrylates and polyethylene glycol di(meth)acrylates may be selected based on their general stability or lack of significant volatility so that, once deposited onto a porous substrate, the monomer will be retained in the pores of the substrate following the evaporation of solvent from the coatable composition.

Additionally, some embodiments comprise trifunctional monomers such as trifunctional methacrylates and esters thereof in some embodiments, trifunctional monomers may comprise those having a molecular weight of about 1,000 or greater. Suitable trifunctional monomers are commercially available such as, for example, that available under the trade designation “SR9011,” having a molecular weight of 1,073 available from Sartomer Co.

More than one specific monomer may be included within a coatable composition. With further processing, explained herein, the resulting coated porous material can have a number of desired properties such as instant water-wettability as well as low adhesion to bacteria.

In the various embodiments of the invention, polymerization of polymerizable compound such as the foregoing monomer(s) results in a highly crosslinked polymer that is included within a single layer along with the aforementioned EVAL copolymer. Crosslinked polymers can be obtained by polymerization of monomer, oligomer or prepolymer together with a polyfunctional compound (e.g., a crosslinker). In some embodiments, crosslinking is accomplished by use of a highly crosslinkable polymer, in a suitable solvent. To achieve and/or enhance the degree of crosslinking of the polymer in the hydrophilic coating, any of a variety of crosslinking agents may be included in the coatable composition. Examples of crosslinking agents include compounds containing at least two vinyl or acryl groups, for example, 2,2-bis[4-(2-acryloxyethoxy)phenyl]propane, 2,2-bis(4-methacryloxyphenyl)propane, butanediol diacrylate and dimethacrylate, trimethylolpropane diacrylate and dimethacrylate; pentanediol diacrylate and dimethacrylate, pentaerythritol diacrylate and dimethacrylate; 1,6-hexanediol diacrylate; 1,4-cyclohexanediol diacrylate and dimethacrylate; bisphenol A diacrylate and dimethacrylates; ethyoxylated bisphenol A diacrylate and dimethacrylates; 1,10-dodecanediol diacrylate and dimethacrylate; 2,2-dimethylpropanediol diacrylate and dimethacrylate; dipropylene glycol diacrylate and dimethacrylate; tripropylene glycol diacrylate and dimethacrylate; poly(propylene)diacrylate and diamethacrylate; triethylene glycol diacrylate and dimethacrylate; dipentaerythritol dimethacrylate and diacrylate; glycerol tris(acryloxypropyl)ether; trimethylolpropane triacrylate and trimethacrylate; ethoxylated trimethylolpropane triacrylate and trimethacrylate; glycerol trimethacrylate; pentaerythritol triacrylate and trimethacrylate; dipentaerythritol trimethacrylate and triacrylate; isocyanurate triacrylate; pentaerythritol tetraacrylate and tetramethacrylate; dipentaerythritol tetramethacrylate and tetraacrylate; sorbitol pentamethacrylate; dipentaerythritol penta-/hexaacrylate; 1,4-butanediol divinyl ether; triethylene glycol divinyl ether; diallylphthalate; divinylbenzene; trivinylbenzene; divinylnaphthalene; trivinylcyclohexane; divinylsulfone; divinylformamide; N,N′,-methylenebisacrylamide; 1,4-diacryloylpiperazine, N,N′-hexamethylenebisacrylamide, N,N′-octamethylenebisacrylamide, N,N-dodecamethylenebisacrylamide, N,N′-bisacrylamidoacetic acid. Particularly preferred crosslinking agents include N,N′,-methylenebisacrylamide, diethylene glycol diacrylate and dimethacrylate, ethylene glycol diacrylate and dimethacrylate, tetra(ethylene glycol)diacrylate, 1,6-hexanediol diacrylate, divinylbenzene, poly(ethylene glycol)diacrylate (e.g., having a mw of 300 or greater as previously mentioned herein), trimethylolpropane triacrylate (TRIM).

In some embodiments, the polymerization reaction is initiated using thermal activation or ultraviolet (UV) irradiation. In embodiments where the polymerization reaction is UV initiated, the coatable composition typically includes a suitable photoinitiator which may be selected from, for example, 2-hydroxy-1[4-2(hydroxyethoxy)phenyl]-2-methyl-1-propanone (IRGACURE 2959), and 2,2-dimethoxy-2-phenylacetophenone (DMPA). Another initiator is 2-hydroxy-2-methyl-1-phenyl-1-propanone available commercially under the trade designation DAROCUR 1173 (Ciba Specialty Chemicals Corporation, Tarrytown, N.Y.). Still another suitable photoinitiator is 2,4,6-trimethylbenzoylphenyl phosphinate available from BASF under the trade designation “Lucirin TPO.”

Other photoinitiators include benzophenone, benzoin and benzoin ethers such as benzoin ethyl ether and benzoin methyl ether, dialkoxyacetophenones, hydroxyalkylphenones, and a-hydroxymethyl benzoin sulfonic esters.

In certain embodiments, the coatable composition is formulated with a reactive photoinitiator which acts to photoinitiate the polymerization reaction and is itself polyfunctional and, therefore, capable of acting like a crosslinking agent. In such an embodiments, a suitable reactive photoinitiator is VAZPIA which is 2-[4-(2-hydroxy-2-methylpropanoyl)phenoxy]ethyl-2-methyl-2-N-propenoylamino propanoate, as described in U.S. Pat. No. 5,506,279.

The coatable composition includes solvent. In various embodiments, a suitable solvent is an aqueous based solvent, typically including an alcohol and optionally another small organic molecule miscible with water and useful in compatibilizing the solvent with the various organic components therein. Suitable solvent include, for example, a 70:30 volume/volume mixture of ethanol/water. In some embodiments, aqueous based solvents may be formulated to organic components other than ethanol such as, for example, methanol, n-propanol (up to 90%), isopropanol, t-butanol, butanol, 2-methoxypropanol, acetone, THF. Other materials can be used as will be known by those of ordinary skill in the art. In general, solvent should be chosen for its compatibility with the other materials included in the coatable composition and for the ease by which it can be volatilized, as is explained elsewhere herein.

In some embodiments, thermal initiator is included in the coatable composition. Thermal initiator may be desired in embodiments wherein the monomer in the coatable composition is prepolymerized in that at least a portion of the composition is partially polymerized or oligomerized prior to applying the coatable composition to the substrate. Prepolymerization may be achieved by thermal activation using a thermal initiator. Suitable thermal initiators include for example 1,1′-azobis(cyclohexanecarbonitrile) (VAZO® catalyst 88), azobis(isobutyronitrile) (AIBN), 4,4′-azobis(4-cyanopentanoic acid), potassium persulfate, ammonium persulfate, and benzoyl peroxide.

The coatable composition is prepared by mixing the foregoing components in a solvent. Those of ordinary skill in the art will appreciate that the exact order of mixing and the relative proportions of the foregoing components and solvent are not limiting. The exact amounts of the various components may be varied within fairly broad limits. EVAL copolymer may be provided in the coatable composition at a concentration less than 15%, in some embodiments less than 10%, in some embodiments less that 5% and in some embodiments less that 2%. Polymerizable compound may be present at a concentration less than 15%, in some embodiments less than 10% and in some embodiments less that 5%. Photoinitiator may be present in the coatable composition at a concentration of less than 6%, in some embodiments less than 2% and in some embodiments less than 1%. In some embodiments, the solvent is an aqueous solvent with a compatible organic component. In some embodiments, the solvent can comprise a water/alcohol mixture wherein the volume percentage of alcohol is between about 40% and 90%, between about 55% and 80%, between about 65% and 75%, and in some embodiments the volume percentage of alcohol is about 70%.

### Coated Porous Material

In some embodiments of the invention, articles are provided in the form of coated porous materials suitable for use in filtration applications. The coated porous materials are made according to the process(es) described herein so that finished materials includes a porous substrate, as described herein, with a first major surface and a second major surface and a plurality of pores extending through the substrate generally from the first major surface to the second major surface. Each pore includes an inner pore wall which defines the internal dimension or diameter of the pore. A hydrophilic coating covers at least a portion of the surfaces of the porous substrate, and the coating is affixed or adhered to at least such surfaces of the substrate, including the inner pore walls. As mentioned, the hydrophilic coating comprises EVAL copolymer and at least one crosslinked polymer in a single layer. Not intending to be bound thereby, it is believed that the crosslinked polymer and the EVAL copolymer are formed into an interpenetrating polymer network within the hydrophilic coating. It is believed that the EVAL copolymer remains substantially unreacted with the crosslinked polymer, and the hydrophilic coating is neither grafted nor covalently bonded to the surfaces of the porous substrate. The hydrophilic coating covers the surfaces of the porous substrate without fully occupying the void volume within the pores of the substrate. Liquid passing through the pores of the coated porous material will flow in proximity to the hydrophilic coating and generally not between the coating and the surfaces of the substrate.

Moreover, the hydrophilic coating is “affixed or adhered to” the surfaces of the porous substrate in the sense that the hydrophilic coating is substantially retained within the pores of the substrate when water or an aqueous solution is passed through the coated porous material. In embodiments of the described materials, less than one percent by weight of the hydrophilic coating is lost when the coated porous material is submerged in water for up to 30 days.

In one embodiment, the coated porous material comprises a porous substrate in the form of a TIPS membrane such as a membrane formed from polypropylene or from polyvinylidene fluoride, for example. The hydrophilic coating is comprised of EVAL copolymer and a highly crosslinked polymer derived from polyethylene glycol di(meth)acrylate and VAZPIA reactive photoinitiator provided in sufficient amount to serve as a crosslinker.

In various embodiments, the coated porous materials exhibit a desirable flux or water flow rate as is described in the Test Methods employed for the various Examples herein. This test measures the time for a predetermined volume of water to pass through a substrate, and the water flow rate (flux) is calculated using the time, vacuum pressure, and area of the substrate and is expressed in L/(m².h.psi). For the Coated porous materials of the present invention, the flux (water flow rate) is typically similar to the flux for the uncoated porous substrate, thus indicating that the hydrophilic coating produces little change in pore size as compared with the uncoated porous substrate.

Additionally, embodiments of the coated porous materials exhibit a high surface energy (e.g., higher than the surface energy of the uncoated porous substrate). In some embodiments, the coated porous material exhibits a surface energy of 50 dynes/cm or greater, in some embodiments the coated porous material exhibits a surface energy of 65 dynes/cm or greater, in other embodiments the coated porous material exhibits a surface energy of 80 dynes/cm or greater, and in still other embodiments the coated porous material exhibits a surface energy of 85 dynes/cm or greater.

### Preparation of Coated Porous Materials

In the preparation of coated porous materials according to the invention, coatable composition, prepared as described herein, is applied to a porous substrate. A polymerization reaction in the coatable composition facilitates the formation of the hydrophilic coating on the surfaces of the substrate. Embodiments of such a process are now described.

In some embodiments, to achieve a crosslinked hydrophilic coating as described herein, the coatable composition may be prepared and applied without first prepolymerizing or oligomerizing the polymerizable compound prior to applying coatable composition to a porous substrate. In other word, the coatable composition is prepared with an unreacted polymerizable compound that consists of or comprises monomer, and the composition is applied to the porous substrate without creating conditions under which the monomer would normally react to oligomerize. In some embodiments, the coatable composition is prepared by simply mixing EVAL copolymer with one or more monomer(s), optionally one or more crosslinking agents, and optionally one or more initiators, in one or more suitable solvents. Suitable examples of the foregoing materials are given above.

Components of the coatable composition are blended so that the composition is substantially homogeneous, but may be slightly heterogeneous. The coatable composition is then applied to a suitable porous substrate, typically by soaking the substrate in the coatable composition for a sufficient amount of time to allow the composition to enter and substantially fill the pores of the substrate. Excess coatable composition may be removed from the outer surfaces of the porous substrate by known lamination techniques or the like.

Following removal of solvent, the coated porous substrate is rewetted with a suitable rewetting agent such as water or a suitable aqueous solution including, for example, an aqueous salt (e.g., sodium chloride or other inorganic salt) solution or another aqueous solution of known inorganic or organic materials or the like. In some embodiments, a suitable salt solution comprises an aqueous solution of sodium chloride at a concentration less than about 30% and in some embodiments at a concentration of about 20%. Rewetting agent serves several functions such as, for example, elimination of the inhibiting effects of oxygen during UV curing. Additionally, the rewetting agent reduces the impact of heat generated by UV sources, particularly from medium pressure mercury lamps. Also, the rewetting agent helps to organize polar groups in the monomer molecules of the coatable composition so that, once cured, the hydrophilic coating comprises a high density of polar groups, which contribute to a high surface energy on the finished coated porous material.

In some embodiments, polymerizable compound in the coatable composition comprises one or more polar monomer(s) selected to have limited solubility in the rewetting agent to prevent the loss of monomer into the rewetting agent along with a reduction of the initial monomer concentration. In general, the polar monomer(s) is(are) selected to provide a highly crosslinked polymer possessing certain physical properties such as heat stability, resistance to biomolecule adsorption, resistance to strong alkaline solutions, and having low levels of extractable matter, for example.

Following rewetting of the dried substrate, the polymerization reaction is initiated and allowed to run to completion to form the hydrophilic coating. As already noted, polymerization may be initiated by, for example, thermal activation or by UV irradiation. Thermal activation is generally less preferred because of the tendency of the polymerizable compound(s) (e.g., monomer) to be soluble in the rewetting agent at elevated temperatures. Moreover, initiation of the polymerization reaction by UV irradiation in the presence of a photoinitiator tends to be faster than a reaction initiated by thermal activation. When initiated by UV radiation, the porous substrate containing a coatable composition of monomer (or oligomer), crosslinking agent and photo initiator is subjected to UV irradiation at wavelengths of from about 200 nm to about 600 nm, for a period of a few seconds to a few hours. In some embodiments, UV irradiation can be broad band or narrow band and the intensity of the UV source may be varied within known parameters, typically with peak power densities ranging from 5 to 600 mW/cm² or higher.

In certain embodiments, the porous substrate is provided as a continuous web of material which, following saturation by the coatable composition, may undergo the polymerization reaction in a continuous process in which the web is exposed to UV radiation as it passes underneath or in proximity to a UV source at a controlled speed. In some embodiments, the porous substrate and coatable composition therein are exposed to UV radiation along both major surfaces, either sequentially or simultaneously. Sequential exposure to a UV source typically requires a first exposure to a UV source that has been positioned on one side of the web or substrate. Thereafter, the web is turned over and the second side of the substrate is exposed to substantially the same dose of UV radiation to essentially completely polymerize the polymerizable compound in the pores of the substrate.

Alternatively, multiple UV sources may be simultaneously directed to irradiate opposite sides of the continuous web. In any of the foregoing embodiments, the continuous web may be supported on a carrier. In some embodiments, the web carrier may be selected to permit transmittance of the UV radiation therethrough so that the radiation is not blocked from initiating the polymerization reaction within the pores of the substrate. In some embodiments, biaxially oriented polypropylene (BOPP) film is an example of a material suitable for supporting the substrate during UV irradiation and polymerization. In some embodiments, the saturated porous substrate may be positioned between (e.g., “sandwiched”) layers of BOPP during irradiation. The layers of film on either side of the porous substrate served to support the substrate, allow for the transmittance of UV radiation therethrough and prevent the loss of rewetting solution in and maintain a level of moisture in the substrate during processing.

Following the polymerization reaction, the coated porous material may be washed to remove remaining salt solution, unreacted materials, residual solvent, and the like. The coated porous material may be dried by evaporation of the remaining liquid (e.g., wash water) by evaporation at room temperature or at an elevated temperature.

In specific embodiments, the foregoing process additionally involves an optional prepolymerization or oligomerization step prior to applying the coatable composition to the porous substrate. In such embodiments, the prepolymerization step may be achieved by thermal initiation, in the presence of a thermal initiator, of the polymerization reaction before the coatable composition is applied to a porous substrate. The degree of polymerization achieved in this step is controlled in a known manner by, for example, using a limiting amount of initiator, control of the reaction time and temperature (e.g., by quenching at a predetermined time after initiation) and the like. Following prepolymerization, the coatable composition may be applied to the porous substrate and further processed as described herein. Suitable thermal initiators may be selected from known materials including those previously mentioned.

In still another optional embodiment, the coatable composition is formulated with UV initiator and applied to the porous substrate. Prior to removing solvent from the coatable composition as described herein, the composition is subjected to a first or initial exposure of UV radiation to initiate a prepolymerization step. In such embodiments, the prepolymerization reaction is controlled to permit the reaction of monomer and to provide oligomers but to avoid running the reaction to completion (e.g., full polymerization) at this stage of the manufacturing process. The degree of pre-polymerization or oligomerization may be controlled by, for example, the use of a limited amount of a first initiator as is further explained herein, by control of the UV exposure (e.g., control of exposure time) or the like. In embodiments utilizing UV radiation to initiate a prepolymerization or oligomerization reaction, the initiator may be selected for its sensitivity to a selected first UV wavelength that is used only during the prepolymerization step, and wherein the first UV wavelength is different than the UV wavelength that is used to fully polymerize the polymerizable compound. In such embodiments, the coatable composition can be formulated to include more than one UV initiator—i.e., a first initiator to sensitive to a first UV wavelength effective to initiate the oligomerization reaction and a second initiator sensitive to a second UV wavelength that is effective to initiate the polymerization reaction previously described. Following the oligomerization step, the remaining process is as previously described—i.e., following initial UV exposure, solvent is removed from the coatable composition and a rewetting solution (e.g., aqueous NaCl) is applied to the substrate and the rewetted substrate is again UV irradiated to complete the polymerization reaction and provide a hydrophilic coating. As already mentioned, the resulting coated porous material is then washed and dried.

### Use of the Coated Porous Material

The various embodiments of the invention include articles (e.g., coated porous materials) and processes (e.g., for the manufacture of coated porous materials). The coated porous materials of the invention may be used in any of a variety of filtration applications including ultrafiltration, wherein the hydrophilic coating can be either charged or neutral, and in microfiltration for use in, for example, health care, food & beverage, and/or industrial markets. Specific applications can include fuel cell and battery separator applications, for example.

The coated porous materials of the invention may be used to carry out separations in aqueous media as well as in non-aqueous fluids. The coated porous materials may be provided as membranes, films and/or as components in any of a variety of articles made for filtration applications. The coated porous materials of the invention are capable of being flexed, folded, or pleated without breaking or crumbling to the touch, making them suitable for use in a filter cartridge or in other filtration devices requiring high surface area materials. Moreover, coated porous materials comprised of membrane materials as the porous substrate can provide low fouling propensity and a high filtration efficiency.

In some embodiments, the coated porous materials described herein may be further modified by depositing any of a variety of compositions thereon using known coating or deposition techniques. For example, the coated porous materials may be metal coated using vapor deposition or sputtering techniques, or the coated porous materials may be coated with adhesive, aqueous or solvent based coating compositions or dyes, for example.

In some embodiments, unique articles are provided by laminating coated porous materials to another structure or material, such as other sheet materials (e.g., fabric layers, woven, nonwoven, knitted, or mesh fabrics), polymeric film layers, metal foil layers, foam layers, or any combination thereof to provide composite structures. Lamination can be accomplished using conventional techniques that include adhesive bonding, spot welding, or by other techniques that do not destroy or otherwise interfere with the desired porosity of the coated porous material. Multilayered filtration articles may additionally be made from (i) one or more layers of coated porous materials based on a porous substrate in the form of a membrane as described herein, and (ii) one or more layers of coated porous materials based on a porous substrate in the form of a nonwoven, for example. In some embodiments, other materials may also be included in a multilayered filtration article so that some of the layers are coated porous materials, as described herein, and the other layers comprise membrane(s) or fibrous filtration constructions other than those described herein.

Additional aspects of the invention and embodiments thereof are further illustrated in the following non-limiting Examples.

### EXAMPLES

### Test Methods

### Membrane Surface Energy

Dyne solutions from two different sets (30-70 dynes/cm from Jemmco, LLC, Mequon WI; 73-87 dyne/cm solutions formulated according to Handbook of Chemistry and Physics, 71^{st} edition, CRC press) were used. All solutions were dropped onto a substrate (e.g., a membrane) using a plastic pipette. The drop volume was about 0.5 ml. The time for a dyne solution to penetrate through the membrane was recorded by a stopwatch. A light trans-illuminator was used for easy detection of the dyne solution penetration. The membrane surface energy was recorded as the surface tension of the highest dyne solution which penetrated through the membrane in less than one second. Three test replicates were used and averaged for each measurement.

### Flux (Water Flow Rate)

A 47 mm disk of a test substrate was mounted in a Gelman magnetic holder (Gelman Sciences, Inc., Ann Arbor, Mich.). The active substrate diameter in the holder was 34 mm. A vacuum pump running at approximately 60 cm (23.5 inches) of mercury (Hg) was applied to draw water through the substrate. The time for 100 ml water to pass through the substrate was recorded with a stopwatch. The water flow rate (flux) was calculated using the time, vacuum pressure, and area of the substrate and expressed in L/(m².h.psi). Two to three test replicates were used and averaged for each measurement.

### Bubble Point Pore Size

The bubble point pore sizes of the substrates were measured according to ASTM-F316-03. A substrate was pre-wetted with isopropanol and then mounted onto a test holder. Pressurized nitrogen gas was gradually applied to one side of the substrate until the gas flow detected at the other side reached 100%. The pressure at 100% gas flow through the substrate was recorded and used to calculate the bubble point pore size. Two to three replicates were used and averaged for each measurement.

### Thermal Resistance Testing

The sample substrates were first completely wetted by immersing in them in deionized water and then placed between a sandwich of two paper towel sheets. The test sandwich was placed in a Thelco Lab Oven (Thermo Electron Corporation, Marietta, Ohio) for 30 min with a set point temperature of 136° C. The substrate was then tested for water wettability and surface energy according to the above test methods.

### Example 1

A 5.0 wt % stock solution was made by dissolving an EVAL copolymer having a 44 mol % ethylene content (EVAL44, Sigma-Aldrich, St. Louis, Mo.) in an ethanol (AAPER Alcohol and Chemical Co. Shelbyville, Ky.)/water solvent mixture (70.0 vol % ethanol) in a water bath at a temperature range of 70-80° C. A coatable composition was made from the above stock solution by adding 4.0 wt % polyethylene glycol diacrylate (SR610, Sartomer, Warrington, Pa.) and 1.0 wt % reactive photoinitiator VAZPIA (2-[4-(2-hydroxy-2-methylpropanoyl)phenoxy]ethyl-2-methyl-2-N-propenoylamino propanoate, (disclosed in U.S. Pat. No. 5,506,279) in ethanol/water mixture solvent (70.0 vol % ethanol). The final concentration of the EVAL in the coatable composition was 1.0 wt %.

A microporous polypropylene membrane (F100, 3M Purification Inc. Meriden, Conn.) was saturated with the coatable composition by placing samples of the membrane ranging from 516 cm² to 1426 cm² in a heavy weight polyethylene (PE) bag along with 10 to 100 ml of coatable composition and letting the composition soak into the membrane for a minute or less. Excess coatable composition on the surface of the membrane was then removed with by blotting on a paper towel after the membrane was removed from the PE bag. The membrane was allowed to dry at room temperature for 10-12 hours. The dried membrane was placed into another PE bag and 10 to 100 ml of rewetting solution,—i.e. 20.0 wt % NaCl aqueous solution was added into the bag. The membrane was instantly wetted with the salt solution and was then removed from the bag. The coatable composition was cured by passing the membrane on a conveying belt through a nitrogen inert Fusion UV system equipped with an H-bulb with an aluminum reflector. The speed of the belt was 6.1 meters/min (20 feet/minute). The membrane was then turned over to expose the other side to the UV source and passed through the UV system again at 6.1 meters/min (20 feet/minute) to provide a coated porous material.

The coated porous material was then washed in de-ionized water and dried at 90° C. (194° F.) in a speed dryer (Emerson Speed Dryer Model 130, Emerson Apparatus Company, Gorham, Me.) for about one hour.

The coated porous material was tested according to the above test methods. The material exhibited a surface energy of 83 dynes/cm, a bubble point pore size of 0.60 nm and water flow rate of 997 L/m².h.psi, as shown in Table 1 below. The uncoated base membrane was also tested, exhibiting a bubble point pore size of 0.61 μm and water flow rate of 973 L/m².h.psi., thus indicating that the cured membrane maintained its pore microstructure and that there was insignificant plugging of the pores resulting in a slight flux change.

The coated porous material was autoclaved while restrained in a frame using a Model EZ10 (Tuttnauer Company, Hauppauge, N.Y.) for 5 cycles, each cycle being 30 minutes at 126° C. (259° F.). The coated porous material was then tested again to measure water flow rate and surface energy. The surface energy was maintained at 87 dynes/cm and the water flow rate was 924 L/m².h.psi, thus indicating that the coated porous material can withstand a high temperature autoclave treatment and that the hydrophilic coating is thermally stable.

### Example 2

As in Example 1, a coated porous material was prepared using a porous substrate in the form of a microporous polypropylene membrane and a coatable composition containing 2.0 wt % polyethylene glycol diacrylate (SR610). The coated porous material exhibited a surface energy of 72 dynes/cm, a bubble point pore size of 0.53 μm and water flow rate of 811 L/m².h.psi, as shown in Table 1 below.

### Example 3

As in Example 2, a coated porous material was prepared using a porous substrate in the form of a microporous polypropylene membrane except the coatable composition contained 1.0 wt % photoinitiator (IRGACURE 2959, Ciba/BASF, Terrytown, N.Y.). The coated porous material exhibited a surface energy of 61 dynes/cm, a bubble point pore size of 0.57 μm and water flow rate of 923 L/m².h.psi, as shown in Table 1 below.

### Example 4

As in Example 3, a coated porous material was prepared using a porous substrate in the form of a microporous polypropylene membrane except the coatable composition contained 4.0 wt % polyethylene glycol diacrylate (SR610). The coated porous material was washed in de-ionized water and dried at 66° C. (150° F.) in a speed dryer (Emerson Speed Dryer Model 130) for approximately 2 hours. The coated porous material had a surface energy of 87 dynes/cm, a bubble point pore size of 0.55 μm and water flow rate of 771 L/m².h.psi as shown in Table 1 below.

### Example 5

As in Example 4, a coated porous material was prepared using a porous substrate in the form of a microporous polypropylene membrane except the photoinitiator used in the coatable composition was 1.0 wt % DAROCUR 1173 (Ciba/BASF, Terrytown, N.Y.). The coated porous material was washed in de-ionized water and dried at 66° C. (150° F.) in a speed dryer (Emerson Speed Dryer Model 130) for about 2 hours. The coated porous material had a surface energy of 87 dynes/cm, a bubble point pore size of 0.53 μm and water flow rate of 704 L/m².h.psi as shown in Table 1 below.

### Example 6

As in Example 4, a coated porous material was prepared using a porous substrate in the form of a microporous polypropylene membrane except the photoinitiator used in the coatable composition was 0.2 wt % LUCIRIN TPO-L 1173 (BASF, Ludwigshafen, Germany). The Fusion UV system used a D-bulb with a dichloric reflector instead of the H-bulb. The coated porous material was washed in de-ionized water and dried at 66° C. (150° F.) in a speed dryer (Emerson Speed Dryer Model 130) for approximately 2 hours. The coated porous material had a surface energy of 87 dynes/cm, a bubble point pore size of 0.56 μm and water flow rate of 777 L/m².h.psi as shown in Table 1 below.

### Example 7

A coated porous material was prepared as in Example 1 using a porous substrate in the form of a microporous polypropylene membrane except the coatable composition contained 0.5 wt % VAZPIA photoinitiator. The coated porous material exhibited a surface energy of 87 dynes/cm, a bubble point pore size of 0.54 μm and water flow rate of 725 L/m².h.psi as shown in Table 1 below.

### Example 8

A coated porous material was prepared as in Example 2 using a porous substrate in the form of a microporous polypropylene membrane except the coatable composition contained 0.2 wt % VAZPIA photoinitiator. The coated porous material exhibited a surface energy of 62 dynes/cm, a bubble point pore size of 0.47 μm and water flow rate of 743 L/m².h.psi as shown in Table 1 below.

### Comparative Example 1

A coated porous material was prepared as in Example 1 using a porous substrate in the form of a microporous polypropylene membrane except the coatable composition did not contain any ethylene-vinyl alcohol copolymer (EVAL). The coatable composition was not cured with UV radiation. The resulting material exhibited a surface energy of 37 dynes/cm and was not wettable in water or in a sodium chloride solution after a 10 minute soak in either rewetting solution.

### Example 9

A coated porous material was prepared as in Example 1 using a porous substrate in the form of a microporous polypropylene membrane except the EVAL copolymer used in the stock solution had a 27 mol % ethylene content (EVAL27, Sigma-Aldrich, St Louis, Mo.) and a 73 mol % vinyl acetate content. A coatable composition was made from the stock solution by adding 4.0 wt % polyethylene glycol diacrylate (SR610) and 1.0 wt % VAZPIA reactive photoinitiator in ethanol/water mixture solvent (70.0 vol % ethanol). The final concentration of the EVAL in the coatable composition was 2.0 wt %. The coated porous material exhibited a surface energy of 87 dynes/cm, a bubble point pore size of 0.56 μm and water flow rate of 846 L/m².h.psi as set forth in Table 1.

### Example 10

A coated porous material was prepared as in Example 1 using a porous substrate in the form of a microporous polypropylene membrane except the polyethylene glycol dimethacrylate used in the coatable composition had a molecular weight of about 400 (SR6030P from Sartomer, Warrington, Pa.) and water was used as the rewetting agent in place of a salt solution. The coated porous material exhibited a surface energy of 77 dynes/cm, a bubble point pore size of 0.56 μm and water flow rate of 885 L/m².h.psi as set forth in Table 1.

### Example 11

A microporous polypropylene membrane was prepared as in Example 1 above except the polyethylene glycol dimethacrylate used in the stock solution had a molecular weight of 750 (PEG750DMA, Sigma-Aldrich, St. Louis, Mo.). The membrane was treated with the coating solution in the same process as described in Example 1. The cured membrane exhibited a surface energy of 80 dynes/cm, a bubble point pore size of 0.61 μm and water flow rate of 960 L/m².h.psi as set forth in Table 1.

### Example 12

A coated porous material was prepared as in Example 1 using a porous substrate in the form of a microporous polypropylene membrane except the polyethylene glycol acrylate used in the coatable composition was ethoxylated trimethylolpropane triacrylate ester (SR415 from Sartomer, Warrington, Pa.). The coated porous material exhibited a surface energy of 78 dynes/cm, a bubble point pore size of 0.56 μm and water flow rate of 867 L/m².h.psi as set forth in Table 1.

### Example 13

A coated porous material was prepared as in Example 1 using a porous substrate in the form of a microporous polypropylene membrane except the coatable composition was made with 1.0 wt % of the EVAL44 stock solution described in Example 1, 2.0 wt % trifunctional monomers (SR9011, Sartomer, Warrington, Pa.), 2.0 wt % methoxy polyethylene glycol 550 methacrylate (CD552, Sartomer, Warrington, Pa.) and 1.0 wt % VAZPIA in an ethanol/water mixture (70 vol % ethanol). The coated porous material exhibited a surface energy of 80 dynes/cm, a bubble point pore size of 0.64 μm and water flow rate of 1099 L/m².h.psi as set forth in Table 1.

### Example 14

A coated porous material was prepared as in Example 2 using a porous substrate in the form of a microporous polypropylene membrane except that the dry membrane was saturated with Mill-Q purified water (Millipore water purification system) before the UV irradiation step. The coated porous material was washed and dried at 90° C. (194° F.) in the speed dryer. The coated porous material exhibited a surface energy of 58 dynes/cm, a bubble point pore size of 0.53 μm and water flow rate of 753 L/m².h.psi as set forth in Table 1.

### Example 15

A coated porous material was prepared as in Example 14 using a porous substrate in the form of a microporous polypropylene membrane except the coatable composition of Example 1 was used. The coated porous material exhibited a surface energy of 74 dynes/cm, a bubble point pore size of 0.58 μm and water flow rate of 982 L/m².h.psi as set forth in Table 1.

### Example 16

A coated porous material was prepared as in Example 2 using a porous substrate in the form of a microporous polypropylene membrane except the speed of the belt was 12.2 meters/min (40 feet/minute). The coated porous material exhibited a surface energy of 73 dynes/cm, a bubble point pore size of 0.53 μm and water flow rate of 811 L/m².h.psi as set forth in Table 1.

### Example 17

A coated porous material was prepared as in Example 1 using a porous substrate in the form of a microporous polypropylene membrane except the speed of the belt was 12.2 meters/min (40 feet/minute). The coated porous material exhibited a surface energy of 85 dynes/cm, a bubble point pore size of 0.59 μm and water flow rate of 929 L/m².h.psi as set forth in Table 1.

### Example 18

A coated porous material was prepared as in Example 2 using a porous substrate in the form of a microporous polypropylene membrane except the saturated membrane was left in the polyethylene bag and placed underneath a UV tray equipped with Quantum Lamps (Quantum UV Curing System, Quant 48, UV Quantum Technologies, Inc., Irvine, Calif.) for a five minute irradiation time. The bag/membrane was turned over and irradiated for an additional five minutes. The coated porous material exhibited a surface energy of 72 dynes/cm, a bubble point pore size of 0.58 μm and water flow rate of 902 L/m².h.psi as set forth in Table 1.

### Example 19

A coated porous material was prepared as in Example 1 using a porous substrate in the form of a hydrophobic polyvinylidene fluoride (PVDF) microporous membrane (DURAPORE, 0.2 micron rating, Millipore, Billerica, Mass.) was used in place of the polypropylene membrane. The coated porous material and the uncoated porous substrate were each tested according to the test methods herein. The coated porous material exhibited a surface energy of 87 dynes/cm, a bubble point pore size of 0.49 μm and water flow rate of 548 L/m².h.psi. After thermal resistance testing, the surface energy of the coated material was 73 dynes/cm, indicating the coated material still had instant water wettability. The test data is set forth in Table 2.

### Example 20

A coated porous material was prepared as in Example 19 above except another hydrophobic polyvinylidene fluoride (PVDF) microporous membrane (DURAPORE, 0.45 micron rating, Millipore, Billerica, Mass.) was used. The coated porous material and the uncoated porous substrate were each tested according to the test methods herein. The coated porous material exhibited a surface energy of 87 dynes/cm, a bubble point pore size of 0.75 μm and water flow rate of 1545 L/m².h.psi. After thermal resistance testing, the surface energy of the coated material was 80 dynes/cm, indicating the coated material maintained excellent water wettability. The test data is set forth in Table 2.

### Example 21

A 5.0 wt % stock solution was made by dissolving an EVAL copolymer (EVAL27 obtained from Sigma-Aldrich, St. Louis, Mo. having a 27 mol % ethylene content and a 73 mol % vinyl acetate content) in an ethanol (AAPER Alcohol and Chemical Co. Shelbyville, Ky.)/water solvent mixture (70.0 vol % ethanol) under heat from a water bath at a temperature in the range of 70-80° C. A monomer solution was made by mixing 124.98 grams of the above stock solution with 10.02 grams of polyethylene glycol dimethylacrylate (SR750, Sigma-Aldrich, St. Louis, Mo.) and 2.5063 grams of N,N′-methylenebisacrylamide (Alfa Aesar, Ward Hill, Mass.) and 0.7536 grams of 2-[4-(2-hydroxy-2-methylpropanoyl)phenoxy]-ethyl-2-methyl-2-N-propenoylamino propanoate (VAZPIA) and 0.5040 grams of 4,4′-azobis(4-cyanopentanoic acid) (Sigma Aldrich, St. Louis, Mo.) and 112.10 grams of an ethanol/water (70:30 volume ratio) mixture. The monomer solution was then bubbled with nitrogen for two minutes and then tightly sealed in a glass bottle. Prepolymerization was initiated by immersing the bottle in a hot water bath held at a temperature of 78° C. The solution was magnetically stirred and heated for 15 minutes and then removed from the hot water bath and immediately immersed in cold water to stop further polymerization. The resulting coatable composition was translucent.

A porous substrate in the form of a microporous polypropylene membrane (F101, 3M Purification Inc., Meriden, Conn.) was saturated with the above prepolymerized coatable composition by placing a sample (approximately 387 cm²) of the membrane in a heavy weight polyethylene (PE) bag along with a sufficient amount of coating solution to completely wet out the membrane. Excess solution on the surface of the membrane was removed with a paper towel after the membrane was removed from the PE bag. The saturated membrane was allowed to dry at room temperature for 10-12 hours to remove solvent. The dried membrane was then placed a PE bag and a sufficient amount of 20.0 wt % NaCl aqueous wetting solution was introduced into the bag to completely wet out the membrane. The re-wetted saturated membrane was removed from the bag and sandwiched between two sheets of biaxially oriented polypropylene (BOPP) film and the sandwich was laminated using a thermal roll laminator (GBC Catena 35, Lincolnshire, Ill.) at room temperature. The laminated membrane was then cured by passing it on a conveying belt through a 600 watt Fusion UV system (without inert Nitrogen) equipped with an H-bulb operating at 100% power. The speed of the belt was 9.1 meters/min (30 feet/minute). The membrane was then turned over to expose the other side to the UV source and passed through the UV system again at 9.1 meters/min (30 feet/minute). Following removal of the BOPP films, the resulting coated porous material was washed in de-ionized water and dried at 66° C. (150° F.) in a speed dryer (Emerson Speed Dryer Model 130) for about 2 hours. The coated porous material and the uncoated porous substrate were tested for surface energy, bubble point pore size and water flow rate. Coated porous material was autoclaved while restrained in a frame using a Model EZ10 autoclave (Tuttnauer Company, Hauppauge, N.Y.) for one cycle at 126° C. (259° F.) for 30 min. The coated porous material was tested again to measure surface energy. The surface energy was maintained at 86 dynes/cm. Coated porous material was also subjected to thermal resistance testing. After the testing, the surface energy of the material was 82 dynes/cm, indicating the coated material maintained excellent water wettability. The test data is set forth in Table 2.

### Example 22

A microporous ethylene-chlorotrifluoroethylene copolymer (ECTFE) membrane, as described in PCT International Pub. No. WO 2010/071764, was prepared using a 40 mm twin screw extruder equipped with a hopper, eight zones with independent temperature controls and a liquid reservoir for supplying diluent to the extruder. Halar 902 ECTFE copolymer pellets and ETFE 6235 nucleating agent were introduced into the hopper using a solids feeder and the materials were fed into the extruder which was maintained at a screw speed of 150 rpm. DBS diluent was fed separately from the reservoir into extruder. The weight ratio of ECTFE copolymer/diluent/nucleating agent was 57.0%/42.5%/0.5%. The total extrusion rate was about 13.6 kg/hr (30 lb/hr) and the extruder's eight zones were set to provide a decreasing temperature profile 254° C. to 249° C. The resulting melt mixed composition was uniformly mixed and subsequently pumped through a slot film die maintained at 221° C., and cast onto a patterned casting wheel maintained at a wheel temperature of 32° C. (90° F.) with a casting speed of 3.66 m/min (12 feet/min) to form a sheet-like shaped melt-mixed composition.

The gap between the film die and the casting wheel was 1.9 cm which was believed to be large enough to allow the ETFE polymer nucleating agent to crystallize prior to significant crystallization the ECTFE copolymer. A faint opaque frost line developed within the molten polymer mixture in the air gap before the mixture contacted the casting wheel. The resulting film was washed in-line in a solvent to remove the diluent DBS and then air dried. The washed film was sequentially oriented in the length and cross direction 1.8×2.85. Down web and cross-web orientation was at 110° C. and 154° C., respectively.

The microporous ECTFE material was evaluated and found to be very strong and capable of being flexed, folded, or pleated without breaking or crumbling to the touch. It had an average film thickness of 38 μm; a bubble point pore size of 0.29 μm; a porosity of 61.3%; and the water flow rate of 219 L/m².h.psi.

A monomer solution from the EVAL27 stock solution as described in Example 21 was made by mixing 1.33 wt % polyethylene glycol 1000 dimethacrylate (PEG1000DMA, Polysceinces, Inc., Warrington, Pa.) and 0.67 wt % polyethylene glycol dimethacrylate (Mₙ 330, Sigma-Aldrich, St. Louis, Mo.), 1.00 wt % N,N′-methylenebisacrylamide (Alfa Aesar, Ward Hill, Mass.) and 0.30 wt % IRGACURE 2959 and 0.20 wt % 4,4′-azobis(4-cyanopentanoic acid) in an ethanol/water (70:30 volume ratio) mixture. The final mixture contained 2.00 wt % EVAL27. This monomer solution was then bubbled with nitrogen for two minutes and then tightly sealed in a 125 ml glass bottle. The bottle was then immersed in a hot water bath held at a temperature of 75° C. The solution was stirred and heated for 15 minutes and then removed from the hot water bath and immediately immersed in cold water to stop any further polymerization resulting in a translucent solution.

The foregoing ECTFE microporous membrane was modified with the above prepolymerized solution using the same procedure described in Example 21 except the speed of the belt was 12.2 meter (40 feet) per minute. The cured and washed membrane was dried at 90° C. (194° F.) in a speed dryer (Emerson Speed Dryer Model 130, Emerson Apparatus Company, Gorham, Me.) for about one hour. Surface energy, bubble point pore size and water flow rate were determined according to the test methods herein for the coated porous material. Surface energy and water flow rate were also determined for the untreated porous substrate. The test results are set forth in Table 2.

### Example 23

A two-zone microporous polypropylene membrane was prepared, as described in PCT International Pub. No. WO 2010/078234, using both a 40 mm twin screw extruder and a 25 mm twin screw extruder. Melt streams from the two extruders were cast into a single sheet through a multi-manifold die.

Melt stream 1. Polypropylene (PP) resin pellets (F008F from Sunoco Chemicals, Philadelphia, Pa.) and a nucleating agent (MILLAD® 3988, Milliken Chemical, Spartanburg, S.C.) were introduced into a 40 mm twin screw extruder which was maintained at a screw speed of 250 rpm. The mineral oil diluent (Mineral Oil Superla White 31 Amoco Lubricants) was fed separately from the reservoir into extruder. The weight ratio of PP/diluent/nucleating agent was 29.25%/70.7%/0.05%. The total extrusion rate was about 30 lb/hr (13.6 kg/hr) and the extruder's eight zones were set to provide a decreasing temperature profile from 271° C. to 177° C.

Melt stream 2. PP resin pellets and Millad 3988 were introduced into a 25 mm twin screw extruder which was maintained at a screw speed of 125 rpm. The mineral oil diluent was fed separately from the reservoir into the extruder. The weight ratio of PP/diluent/nucleating agent was 29.14%/70.7%/0.16%. The total extrusion rate was about 6 lb/hr (2.72 kg/hr) and the extruder's eight zones were set to provide a decreasing temperature profile from 271° C. to 177° C.

The two-zone film was cast from the multi-manifold die maintained at 177° C. (350° F.) onto a patterned casting wheel. The temperature of casting wheel was maintained at 60° C. (140° F.) and the casting speed was 3.35 m/min (11 ft/min). The resulting film was washed in-line in a solvent to remove mineral oil in the film and then air dried. The washed film was sequentially oriented in the length and cross direction 1.8×2.80 at 99° C. (210° F.) and 154° C. (310° F.), respectively.

The multizone microporous polypropylene membrane R1901-11 prepared above was used to make a coated porous material according to the procedure described in Example 2. The coated porous material was water-wettable. Surface energy, bubble point pore sizes and water flow rates were determined according to the test methods herein for both the untreated porous substrate and the coated porous material. The test results are set forth in Table 2.

### Example 24

A two-zone microporous polypropylene membrane was prepared, as described in PCT International Pub. No. WO 2010/078234, using both a 40 mm twin screw extruder and a 25 mm twin screw extruder. Melt streams from the two extruders were cast into a single sheet through a multi-manifold die.

Melt stream 1. Polypropylene (PP) resin pellets (F008F from Sunoco Chemicals, Philadelphia, Pa.) and a nucleating agent (MILLAD® 3988, Milliken Chemical, Spartanburg, S.C.) were introduced into a 40 mm twin screw extruder which was maintained at a screw speed of 250 rpm. The mineral oil diluent (Mineral Oil Superla White 31 Amoco Lubricants) was fed separately from the reservoir into extruder. The weight ratio of PP/diluent/nucleating agent was 29.254%/70.7%/0.045%. The total extrusion rate was about 27 lb/hr (12.2 kg/hr) and the extruder's eight zones were set to provide a decreasing temperature profile from 271° C. to 177° C.

Melt stream 2. PP resin pellets and Millad 3988 were introduced into a 25 mm twin screw extruder which was maintained at a screw speed of 125 rpm. The mineral oil diluent was fed separately from the reservoir into extruder. The weight ratio of PP/diluent/nucleating agent was 28.146%/70.7%/0.154%. The total extrusion rate was about 9 lb/hr (4.08 kg/hr) and the extruder's eight zones were set to provide a decreasing temperature profile from 271° C. to 177° C.

The two-zone film was cast from the multi-manifold die maintained at 177° C. (350° F.) onto a patterned casting wheel. The temperature of casting wheel was maintained at 60° C. (140° F.) and the casting speed was 3.52 m/min (11.54 ft/min). The resulting film was washed in-line in a solvent to remove the mineral oil diluent and then air dried. The washed film was sequentially oriented in the length and cross direction 1.6×2.85 at 99° C. (210° F.) and 154° C. (310° F.), respectively.

A multizone microporous polypropylene membrane R1901-8B prepared as described above was used to make a coated porous material according to the procedure described in Example 2. Surface energy, bubble point pore sizes and water flow rates were determined according to the test methods herein for both the untreated porous substrate and the coated porous material. The test results are set forth in Table 2.

### Example 25

A two-zone microporous polypropylene membrane as prepared, as described in PCT International Pub. No. WO 2010/078234, using both a 40 mm twin screw extruder and a 25 mm twin screw extruder, each of them equipped with a hopper, eight zones with independent temperature controls and a liquid reservoir for supplying diluent to the extruder. Two melt streams from extruders were casted into a single sheet through a multi-manifold die with an orifice.

Melt stream 1. Polypropylene (PP) resin pellets (F008F from Sunoco Chemicals, Philadelphia, Pa.) and a nucleating agent (MILLAD® 3988, Milliken Chemical, Spartanburg, S.C.) were introduced into the hopper using a solids feeder and the materials were fed into of a 40 mm twin screw extruder which was maintained at a screw speed of 175 rpm. Mineral oil diluent (Kaydol 350 Mineral Oil, Brenntag Great Lakes LCC, St. Paul, Minn.) was fed separately from a reservoir into the extruder. The weight ratio of PP/diluent/nucleating agent was 34.247/65.7%/0.053%. The total extrusion rate was about 32 lb/hr (14.5 kg/hr) and the extruder's eight zones were set to provide a decreasing temperature profile from 271° C. to 177° C.

Melt stream 2. PP resin pellets and Millad 3988 were introduced into a 25 mm twin screw extruder which was maintained at a screw speed of 150 rpm. The mineral oil diluent was fed separately from the reservoir into extruder. The weight ratio of PP/diluent/nucleating agent was 29.14%/70.7%/0.16%. The total extrusion rate was about 6 lb/hr (2.72 kg/hr) and the extruder's eight zones were set to provide a decreasing temperature profile from 254° C. to 177° C.

The two-zone film was cast from the multi-manifold die maintained at 177° C. (350° F.) onto a patterned casting wheel. The temperature of casting wheel was maintained at 71° C. (160° F.) and the casting speed was 5.79 m/min (19.00 ft/min). The resulting film was washed in-line in a solvent to remove mineral oil diluent and then air dried. The washed film was sequentially oriented in the length and cross direction 1.5×2.70 at 99° C. (210° F.) and 160° C. (320° F.), respectively.

A multizone microporous polypropylene membrane R1933-7 prepared as described above was used to make a coated porous material according to the procedure described in Example 2. Surface energy, bubble point pore sizes and water flow rates were determined according to the test methods herein for both the untreated porous substrate and the coated porous material. The test results are set forth in Table 2.

TABLE 1

| | Flux | Bubble point pore | Surface energy |
|---|---|---|---|
| Example | (L/m² · h · psi) | size (microns) | (dynes/cm) |
| 1 | 997 | 0.60 | 83 |
| 2 | 811 | 0.53 | 72 |
| 3 | 923 | 0.57 | 61 |
| 4 | 771 | 0.55 | 87 |
| 5 | 704 | 0.53 | 87 |
| 6 | 777 | 0.56 | 87 |
| 7 | 725 | 0.54 | 87 |
| 8 | 743 | 0.47 | 62 |
| C1 | — | — | 37 |
| 9 | 846 | 0.56 | 87 |
| 10 | 885 | 0.56 | 77 |
| 11 | 960 | 0.61 | 80 |
| 12 | 867 | 0.56 | 78 |
| 13 | 1099 | 0.64 | 80 |
| 14 | 753 | 0.53 | 58 |
| 15 | 982 | 0.58 | 74 |
| 16 | 811 | 0.53 | 73 |
| 17 | 929 | 0.59 | 85 |
| 18 | 902 | 0.58 | 72 |

TABLE 2

| | | | | Surface energy |
|---|---|---|---|---|
| | | | | after (1) thermal |
| | | Bubble point | Surface | resistance testing or |
| | Flux | pore size | energy | (2) autoclave |
| Example | (L/m² · h · psi) | (microns) | (dynes/cm) | (dynes/cm) |
| 19 | 548 | 0.49 | 87 | 73¹ |
| Uncoated membrane of | 683 | 0.51 | 48 | — |
| Example 19 | | | | |
| 20 | 1545 | 0.75 | 87 | 80¹ |
| Uncoated membrane of | 1879 | 0.76 | 50 | — |
| Example 20 | | | | |
| 21 | 1310 | 0.84 | 87 | 82¹, 86² |
| Uncoated membrane of | 1468 | 0.83 | 37 | — |
| Example 21 | | | | |
| 22 | 184 | 0.29 | 79 | — |
| Uncoated membrane of | 219 | — | 38 | — |
| Example 22 | | | | |
| 23 | 2427 | 0.62 | >72 | — |
| Uncoated membrane of | 2723 | 0.74 | 37 | — |
| Example 23 | | | | |
| 24 | 2081 | 0.49 | >72 | — |
| Uncoated membrane of | 1832 | 0.51 | 37 | — |
| Example 24 | | | | |
| 25 | 1401 | 0.34 | 75 | — |
| Uncoated membrane of | 1263 | 0.34 | 37 | — |
| Example 25 | | | | |

Various embodiments of the invention have been described in detail. Those of ordinary skill in the art will appreciated that changes, both foreseeable and unforeseen, may be made to the described embodiments without departing from the true spirit and scope of the invention.

1. A coated porous material comprising:
a) a porous substrate comprising a plurality of pores extending through the substrate from a first major surface to a second major surface, each pore comprising an inner pore wall defining the internal dimension of the pore; and
b) a hydrophilic coating on a plurality of the pore walls, the hydrophilic coating comprising ethylene vinyl alcohol copolymer and at least one crosslinked polymer in a single layer;
wherein the hydrophilic coating comprises an interpenetrating polymer network of ethylene vinyl alcohol copolymer and the crosslinked polymer.

2. The coated porous material of claim 1 wherein the porous substrate is a membrane comprising at least one polymer material.

3. (canceled)

4. The coated porous material of claim 2 wherein the polymer material is selected from the group consisting of ethylene chlorotrifluoroethylene, polytetrafluoroethylene, polysulfone, poly(ether)sulfone, polyolefins, polyvinylidene fluoride, polyamide, cellulose ester and combinations of two or more of the foregoing.

5. The coated porous material of claim 1 wherein the porous substrate comprises material selected from the group consisting of nonwoven material, woven material, knitted material.

6. The coated porous material of claim 1 wherein the at least one crosslinked polymer is derived from monomers selected from the group consisting of polyethylene glycol diacrylate, polyethylene glycol dimethacrylate and combinations thereof.

7. The coated porous material of claim 6 wherein the monomers are of a molecular weight greater than about 400.

8. The coated porous material of claim 6 wherein the at least one crosslinked polymer is derived from a reaction between one or more of the monomers and at least one crosslinking agent.

9. (canceled)

10. A process for the preparation of a coated porous material, the process comprising:
(a) providing a porous substrate comprising a plurality of pores extending through the substrate from a first major surface to a second major surface, each pore comprising an inner pore wall defining the internal dimension of the pore;
(b) applying a coatable composition to at least a portion of the inner pore walls of the porous substrate, the coatable composition comprising ethylene vinyl alcohol copolymer, at least one polymerizable compound and solvent;
(c) removing at least a portion of the solvent from the coatable composition to dry the coatable composition;
(d) saturating the porous substrate and the coatable composition with a rewetting solution; and
(e) polymerizing the polymerizable compound to form a hydrophilic coating on the pore walls and to provide the coated porous material, the hydrophilic coating comprising both the ethylene vinyl alcohol copolymer and a crosslinked polymer in a single layer;
wherein the step (e) of polymerizing the polymerizable compound results in the hydrophilic coating comprising both the ethylene vinyl alcohol copolymer and a crosslinked polymer in an interpenetrating polymer network.

11. The process of claim 10 further comprising partially polymerizing the polymerizable compound in the coatable composition either before or after the step (b) of applying the coatable composition to at least a portion of the inner pore walls:

12. The process of claim 11 wherein the step of partially polymerizing the polymerizable compound comprises thermally initiating a polymerization reaction in the coatable composition to partially polymerize the polymerizable compound before the step (b) of applying the coatable composition to at least a portion of the inner pore walls.

13. The process of claim 11 wherein the step of partially polymerizing the polymerizable compound comprises photo-initiating a polymerization reaction in the coatable composition to partially polymerize the polymerizable compound after the step (b) of applying the coatable composition to at least a portion of the inner pore walls.

14. The process of claim 10, further comprising preparing the coatable composition prior to coating the pore walls therewith, the coatable composition prepared by combining the ethylene vinyl alcohol copolymer and the at least one polymerizable compound in a solvent.

15. The process of claim 14 wherein the at least one polymerizable compound comprises monomer selected from polyethylene glycol diacrylate, polyethylene glycol dimethacrylate and combinations thereof.

16. The process of claim 14 wherein the at least one monomer is initially of a molecular weight greater than about 400.

17. (canceled)

18. (canceled)

19. (canceled)

20. The process of claim 10 wherein the coatable composition further comprises at least one crosslinking agent and photoinitiator and wherein removing at least a portion of the solvent from the coatable composition and the porous substrate to dry the coatable composition is accomplished by evaporating the solvent.

21. The process of claim 20 wherein the rewetting solution comprises a solution of sodium chloride, and step (e) of polymerizing the polymerizable compound comprises photo-polymerizing the at least one polymerizable compound using ultraviolet radiation.

22. The process of claim 20 wherein the photoinitiator comprises a reactive material comprising 2-[4-(2-hydroxy-2-methylpropanoyl)phenoxy]ethyl-2-methyl-2-N-propenoylamino propanoate.

23. (canceled)

24. The process of claim 10 wherein the porous substrate is a membrane.

25. The process of claim 24 wherein the membrane comprises material selected from the group consisting of poly(ether)sulfone, polyolefins, polyvinylidene fluoride, polyamide, cellulose ester and combinations of two or more of the foregoing.

26. The process of claim 10 wherein the porous substrate comprises fibrous material selected from the group consisting of nonwoven material, woven material and knitted material.

27. (canceled)
